(19) United States
(12) Patent Application Publication
(10) Pub. No.: US 2015/0154288 A1
(43) Pub. Date: Jun. 4, 2015

(54) METHOD AND SYSTEM FOR PROCESSING LOG DATA

(71) Applicant: KONKUK UNIVERSITY INDUSTRIAL COOPERATION CORP., Seoul (KR)

(72) Inventors: Myoung Jin KIM, Seoul (KR); Yun CUI, Seoul (KR); Han Ku LEE, Seoul (KR); Seung Ho HAN, Cheonan-si (KR)

(21) Appl. No.: 14/553,905

(22) Filed: Nov. 25, 2014

(30) Foreign Application Priority Data
Nov. 29, 2013 (KR) 10-2013-0147605

(51) Int. Cl. G06F 17/30; G06F 7/24

(52) U.S. Cl. CPC G06F 17/30705; G06F 7/24

(57) ABSTRACT

Provided is a method of processing log data and a system for operating the method, in which the log data processing system may include a first storage module, a second storage module, a log collection module configured to collect log data generated by a task process associated with a customer, classify the log data into first log data and second log data based on a type of the log data, and transmit the first log data to the first storage module and the second log data to the second storage module, and a log graph generation module configured to generate a log data graph of at least one of data stored in the first storage module and data stored in the second storage module.

### CROSS-REFERENCE TO RELATED APPLICATION

This application claims the priority benefit of Korean Patent Application No. 10-2013-0147605, filed on Nov. 29, 2013, in the Korean Intellectual Property Office, the disclosure of which is incorporated herein by reference.

### BACKGROUND

1. Field of the Invention

The present invention relates to a method of processing unstructured log data and a system for operating the method.

2. Description of the Related Art

Log data in which numerous sets of information generated by operations of computer systems are recorded may be used in various fields, for example, inspection of an operation of a computer system, optimization of a process, and provision of a user customized service.

The log data may be mostly generated between customer related task processes. Thus, a system for separately processing log data generated by customer related task processes may be required.

### SUMMARY

According to an aspect of the present invention, there is provided a log data processing system including a first storage module, a second storage module, a log collection module configured to collect log data generated by a task process associated with a customer, classify the log data into first log data and second log data based on a type of the log data, and transmit the first log data to the first storage module and the second log data to the second storage module, and a log graph generation module configured to generate a log data graph of at least one of data stored in the first storage module and data stored in the second storage module.

The log data processing system may further include an analysis module configured to extract log data corresponding to a user query from the second log data transmitted to the second storage module in response to the user query, and analyze the extracted log data using a distributed and parallel processing method. The log graph generation module may generate a log data graph of analysis data obtained by the analysis module.

When the second log data is a large amount of data, the second storage module may transmit the second log data to the analysis module. Here, the large amount of data may indicate big data. The analysis module may then analyze the second log data using the distributed and parallel processing method.

The user query may include at least one of a time based condition, a date based condition, a month based condition, a year based condition, and a branch based condition.

The log collection module may collect the log data during a period of time spanning from a start point of the task process to an end point of the task process.

The first log data may be data requiring a real time analysis, and the second log data may be data requiring a unit time analysis.

The log graph generation module may display the log data graph in a form of a web interface.

The second storage module may perform an autoshading operation on the second log data.

The log collection module may determine the type of the log data based on a parameter included in the log data.

The second storage module may combine the first log information transmitted to the first storage module and information associated with the first log data through a Sqoop and store the combined first log data and the information subsequent to the end point of the task process.

The information associated with the first log data may include at least one of a wait time for the task process, a processing time for the task process, and information on a worker handling the task process.

According to another aspect of the present invention, there is provided a log data processing method of a log data processing system including a first storage module and a second storage module, the method including collecting log data generated by a task process associated with a customer, classifying the log data into first log data and second log data based on a type of the log data and transmitting the first log data to the first storage module and the second log data to the second storage module, and generating a log data graph of at least one of data stored in the first storage module and data stored in the second storage module.

The log data processing method may further include extracting log data corresponding to a user query from the second log data stored in the second storage module in response to the user query, analyzing the extracted log data using a distributed and parallel processing method, and generating a log data graph of analysis data obtained as a result of the analyzing.

The collecting may include collecting the log data during a period of time spanning from a start point of the task process to an end point of the task process.

The transmitting may include determining the type of the log data using a parameter included in the log data.

The log data processing method may further include displaying the log data graph in a form of a web interface.

The log data processing method may further include combining the first log data and information associated with the first log data and transmitting the combined first log data and the information to the second storage module subsequent to the end point of the task process.

The log data processing method may further include performing an autoshading operation on the second log data.

The first log data may be data requiring a real time analysis, and the second log data may be data requiring a unit time analysis.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a log data processing system according to an embodiment of the present invention;

FIG. 2 is a diagram illustrating parameters of log data according to an embodiment of the present invention;

FIG. 3 is a diagram illustrating an example of a configuration of a web interface to describe an operating method of the log graph generation module illustrated in FIG. 1;

FIG. 4 is a data flowchart illustrating an example of an operating method of the log data processing system illustrated in FIG. 1;

FIG. 5 is a data flowchart illustrating another example of an operating method of the log data processing system illustrated in FIG. 1;

FIG. 6 is a data flowchart illustrating still another example of an operating method of the log data processing system illustrated in FIG. 1;

FIG. 7 is a data flowchart illustrating yet another example of an operating method of the log data processing system illustrated in FIG. 1; and

FIG. 8 is a flowchart illustrating an example of an operating method of the log data processing system illustrated in FIG. 1.

### DETAILED DESCRIPTION

Example embodiments will now be described more fully with reference to the accompanying drawings in which example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, the thicknesses of layers and areas are exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

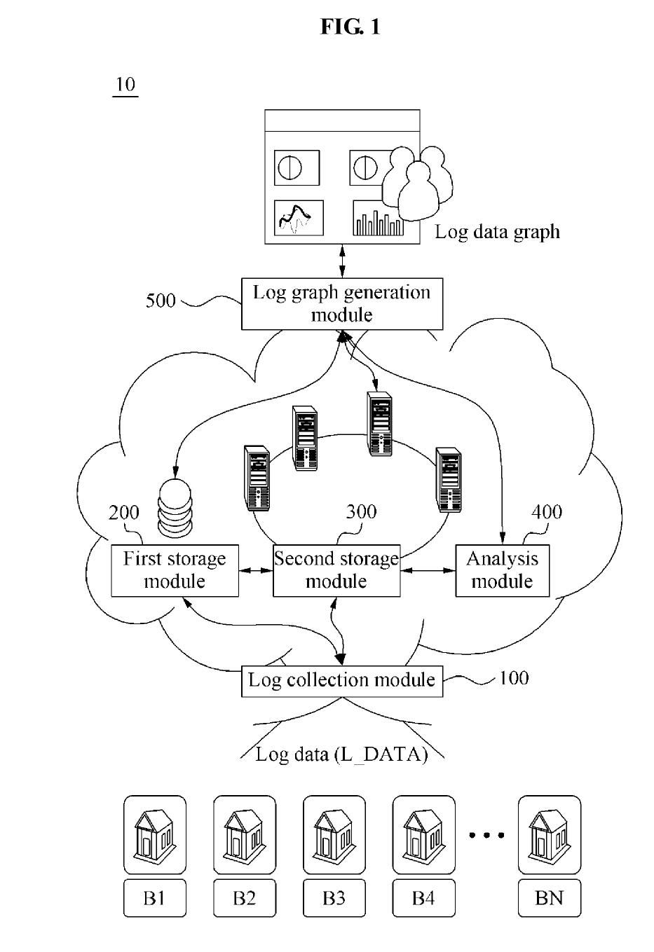

FIG. 1 is a diagram illustrating an example of a log data processing system 10 according to an embodiment of the present invention.

Referring to FIG. 1, the log data processing system 10 includes a log collection module 100, a first storage module 200, a second storage module 300, an analysis module 400, and a log graph generation module 500.

The log data processing system 10 may be a cloud environment based log data processing system to process log data (L-DATA) generated at each of branches, for example, B1 through BN. A branch may be a bank. For example, the log data may be data generated by a task process associated with a customer at a bank. For example, the log data may include unstructured log data, for example, a wait time for a task for the customer and a task processing time, that may be generated through the task process.

The log collection module 100 may collect the log data. For example, the log collection module 100 may collect the log data generated by the task process associated with the customer at each branch. The log collection module 100 may collect the log data during a period of time spanning from a start point of the task process to an end point of the task process at a branch. For example, the task process may include a task process for at least one customer.

The log collection module 100 may transmit the log data to the first storage module 200 and the second storage module 300 based on a type of the log data. For example, the log collection module 100 may classify the log data based on the type of the log data and distribute the classified log data to the first storage module 200 and the second storage module 300.

The log collection module 100 may classify the log data into first log data generated in real time and second log data to be accumulated. For example, the first log data may be data requiring a real time analysis, and the second log data may be data requiring a unit time analysis. The log collection module 100 may transmit the first log data to the first storage module 200. The log collection module 100 may transmit the second log data to the second storage module 200.

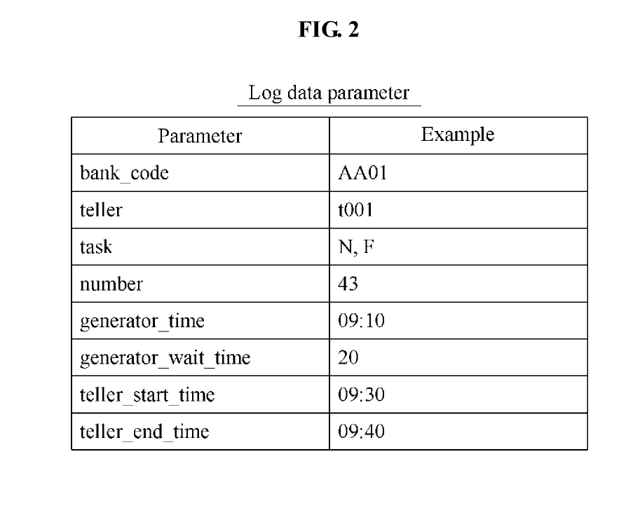

The log collection module 100 may determine the type of the log data using parameters included in the log data. The parameters included in the log data will be described in detail with reference to FIG. 2.

The first storage module 200 may store the first log data transmitted from the log collection module 100. The first storage module 200 may transmit the first log data to the log graph generation module 500. The first storage module 200 may include a relational database for storing the first log data. The relational database may include, for example, MySQL, PostgreSQL, SQLite, Microsoft SQL Server, Microsoft Access, SAP, dBASE, FoxPro, and IBM DB2.

The second storage module 300 may store the second log data transmitted from the log collection module 100. The second storage module 300 may include a non-relational database for storing the second log data. The non-relational database may be, for example, a key-value database, a column-oriented database, and a document-oriented database. The non-relational database may include, for example, Redis, Tokyo Cabinet, Tokyo Tyrant, Memcached, Cassandra, Hbase, HyperTable, MongoDB, CouchDB, and SimpleDB.

The second storage module 300 may divide the second log data into blocks based on an increase in data, and automatically distribute the blocks to a plurality of nodes. For example, the blocks may be data blocks and the nodes may be data nodes. The second storage module 300 may perform an autoshading operation based on the increase in the data. Thus, the second storage module 300 may flexibly expand the nodes and a storage area through the autoshading operation.

The second storage module 300 may reproduce each block to distribute the blocks to the nodes. A number of reproduced blocks may be settable. The number of the reproduced blocks may be at least one. For example, each of the blocks may be set to be a basic data size. For example, the basic data size may be set by an administrator and/or a user.

The second storage module 300 may be protected against a system failure occurring by a data loss by dividing the second log data into the blocks of a predetermined size, reproducing the blocks, and storing the reproduced blocks in each node. Thus, stability of the second storage module 300 and the second log data may be ensured.

The second storage module 300 and the first storage module 200 may communicate with each other through a Sqoop. The second storage module 300 and the first storage module 200 may exchange data, or signals, through the Sqoop. For example, when the task process associated with the customer is terminated at each of the branches B1 through BN, the second storage module 300 may combine the first log data stored in the first storage module 200 and information associated with the first log data and store the combined first log data and the information subsequent to the end point of the task process. The associated information may include, for example, a wait time for the task process, a processing time for the task process, and information about a worker who handles the task process, for example, a name of the worker, a position of the worker, and a number of the worker.

The second storage module 300 may transmit the second log data to the log graph generation module 500. When the second log data is a large amount of data, the second storage module 300 may transmit the second log data to the analysis module 400. The analysis module 400 may analyze the second log data using a distributed and parallel processing method, and transmit analysis data obtained as a result of the analyzing to the log graph generation module 500.

The analysis module 400 may analyze the log data using the distributed and parallel processing method, and transmit the analysis data obtained as the result of the analyzing to the log graph generation module 500. The analysis module 400 may be a Hadoop based analysis module. The analysis module 400 may extract log data corresponding to a user query from the second storage module 300 through a MapReduce.

In an example, the analysis module 400 may analyze the second log data transmitted from the second storage module 300 using the distributed and parallel processing method, and transmit the analysis data to the log graph generation module 500. The second log data may be a large amount of data. When performing the real time analysis on an accumulated large amount of the second log data is required, the analysis module 400 may rapidly and reliably process the second log data using the distributed and parallel processing method.

In another example, the analysis module 400 may extract log data corresponding to a user query from the second log data stored in the second storage module 300 in response to the user query. The user query may include at least one of, for example, a time-based condition, a date-based condition, a month-based condition, a year-based condition, and a branch-based condition. The analysis module 400 may analyze the extracted log data using the distributed and parallel processing method, and transmit analysis data obtained as a result of the analyzing to the log graph generation module 500.

The analysis module 400 may divide the log data, for example, the second log data and the log data corresponding to the user query, into blocks using a high-availability distributed object-oriented platform (Hadoop) distributed file system (HDFS), and automatically distribute the blocks to a plurality of nodes included in the HDFS to store the blocks. When the analysis module 400 distributes each block, the analysis module 400 may reproduce each block to distribute the blocks to the nodes. For example, the blocks may be data blocks and the nodes may be data nodes.

The analysis module 400 may be protected against a system failure occurring due to a data loss by dividing the log data, for example, the second log data and the log data corresponding to the user query, into blocks of a predetermined size using the HDFS, reproducing the blocks, and storing the reproduced blocks in each node included in the HDFS. Thus, stability of the analysis module 400 and the log data may be ensured.

The log graph generation module 500 may generate a log data graph of the first log data transmitted from the first storage module 200. The log graph generation module 500 may generate a log data graph of the second log data transmitted from the second storage module 300. The log graph generation module 500 may generate a log data graph of the analysis data transmitted from the analysis module 400.

The log graph generation module 500 may provide a user with the log data graph in a form of a web interface. For example, the user may be identical to or different from the customer associated with a current task performed at each of the branches B1 through BN.

The modules including the log collection module 100, the first storage module 200, the second storage module 300, the analysis module 400, and the log graph generation module 500 are illustrated as separate severs in FIG. 1. However, the modules may be provided as a single server.

FIG. 2 is a diagram illustrating parameters of log data according to an embodiment of the present invention.

Referring to FIGS. 1 and 2, the parameters of the log data may be predefined to secure accuracy and consistency in information about the log data used in data communication among the modules including the log collection module 100, the first storage module 200, the second storage module 300, the analysis module 400, and the log graph generation module 500.

The log collection module 100 may determine a type of the log data using the parameters included in the log data.

As illustrated in FIG. 2, the parameters of the log data may be defined as at least one of bank_code, teller, task, number, generator_time, generator_wait_time, teller_start_time, and teller_end_time.

The “band_code” may be a parameter indicating a number of each of the branches B1 through BN at which the log data is generated. The “teller” may be a parameter indicating a number of a worker, or a teller, who handles a current task process associated with a customer. For example, a type of the task may include a general task (N) and other task (F). The “number” may be a parameter used to distinguish a number generated from a waiting number system used at each of the branches B1 through BN. The bank_code, the teller, the task, and the number may be the parameters associated with log data being processed in real time by the task process.

The log collection module 100 may classify, as first log data, log data using the bank_code, the teller, the task, and the number among the parameters of the log data.

The “generator_time” may be a parameter used to distinguish a point in time at which a wait number is generated to handle the task process associated with the customer. The “generator_wait_time” may be a parameter to indicate an amount of time before the task process is initiated after the wait number is generated. The “teller_start_time” may be a parameter to record a start point at which the task process is initiated. The “teller_end_time” may be a parameter to record an end point at which the task process is terminated. The generator_time, the generator_wait_time, and the teller_start_time, and the teller_end_time may be the parameters associated with log data to be accumulated by the task process.

The log collection module 100 may classify, as second log data, log data using the generator_time, the generator_wait_time, the teller_start_time, and the teller_end_time among the parameters of the log data.

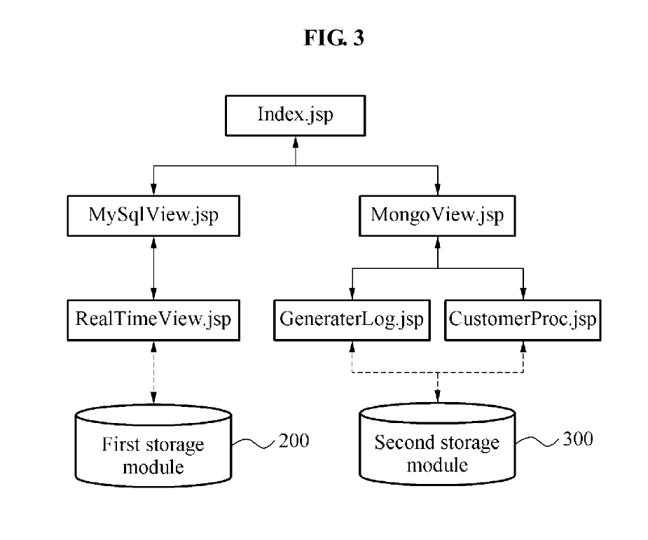

FIG. 3 is a diagram illustrating an example of a configuration of a web interface to describe an operating method of the log graph generation module 500 illustrated in FIG. 1.

Referring to FIGS. 1 and 3, the log graph generation module 500 may generate a log data graph through the web interface, and display the generated log data graph in a form of the web interface. The log graph generation module 500 may provide a user with the generated log data graph in the form of the web interface.

The log graph generation module 500 may generate a log data graph of first log data stored in the first storage module 200 using “RealTimeView.jsp,” transmit the generated log data graph to “MySqlView.jsp,” and display the log data graph in the form of the web interface through “Index.jsp” to allow the user to view the log data graph.

The log graph generation module 500 may generate a log data graph of second log data stored in the second storage module 300 using “GeneraterLog.jsp.” For example, the log graph generation module 500 may generate a log data graph with respect to a number of wait numbers generated for a predetermined period of time and an average wait time for a task process. The log graph generation module 500 may generate a log data graph of the second log data stored in the second storage module 300 using “CustomerProcjsp.” For example, the log graph generation module 500 may generate a log data graph with respect to an average time consumed for the task process and efficiency in handling the task process by a worker. The log graph generation module 500 may transmit the log data graphs generated using the “GeneraterLog.jsp” and the “CustomerProc.jsp” to “MongoView.jsp” and display the log data graphs in the form of the web interface through the “Index.jsp” to allow the user to view the log data graphs.

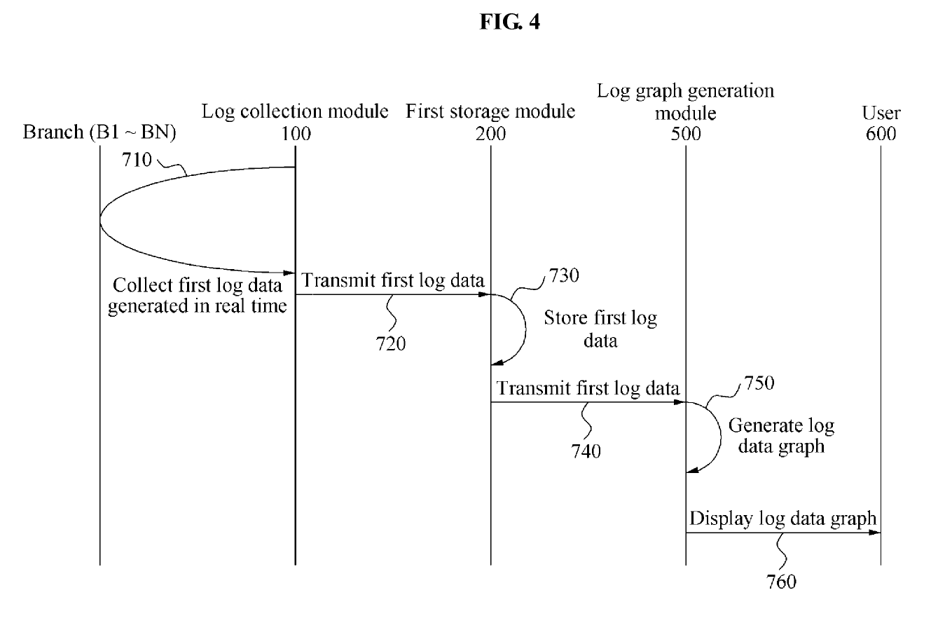

FIG. 4 is a data flowchart illustrating an example of an operating method of the log data processing system 10 illustrated in FIG. 1.

Referring to FIG. 4, in operation 710, the log collection module 100 collects first log data generated in real time by a task process associated with a customer at each of branches B1 through BN. In operation 720, the log collection module 100 transmits the first log data to the first storage module 200.

In operation 730, the first storage module 200 stores the first log data transmitted from the log collection module 100. In operation 740, the first storage module 200 transmits the first log data to the log graph generation module 500.

In operation 750, the log graph generation module 500 generates a log data graph of the first log data transmitted from the first storage module 200. In operation 760, the log graph generation module 500 displays the log data graph in a form of a web interface to allow a user 600 to view the log data graph.

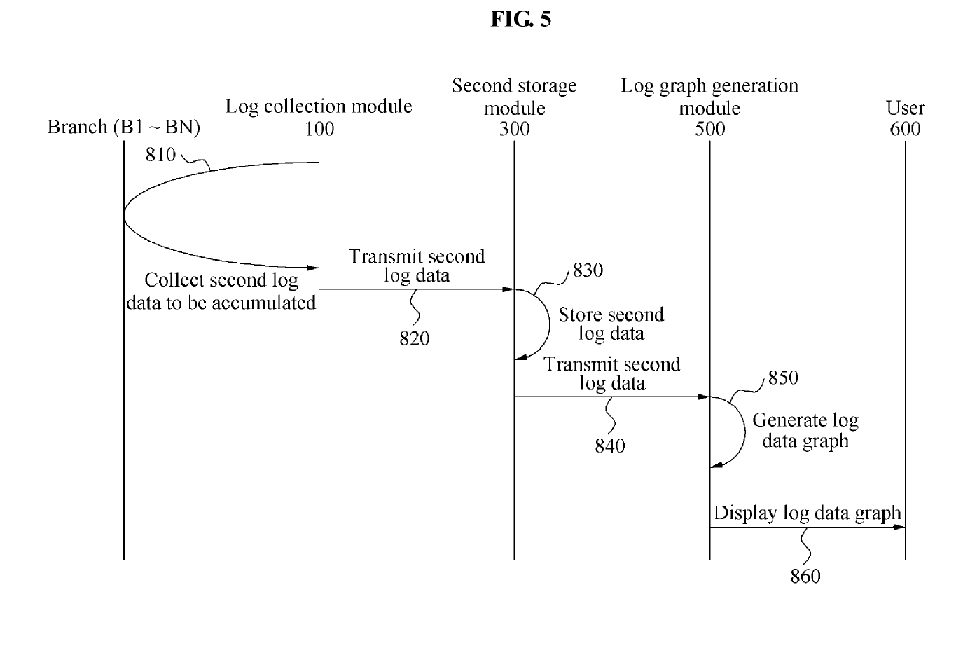

FIG. 5 is a data flowchart illustrating another example of an operating method of the log data processing system 10 illustrated in FIG. 1.

Referring to FIG. 5, in operation 810, the log collection module 100 collects second log data to be accumulated by a task process associated with a customer at each of branches B1 through BN. In operation 820, the log collection module 100 transmits the second log data to the second storage module 300.

In operation 830, the second storage module 300 stores the second log data transmitted from the log collection module 100. In operation 840, the second storage module 300 transmits the second log data to the log graph generation module 500.

In operation 850, the log graph generation module 500 generates a log data graph of the second log data transmitted from the second storage module 300. In operation 860, the log graph generation module 500 displays the log data graph in a form of a web interface to allow the user 600 to view the log data graph.

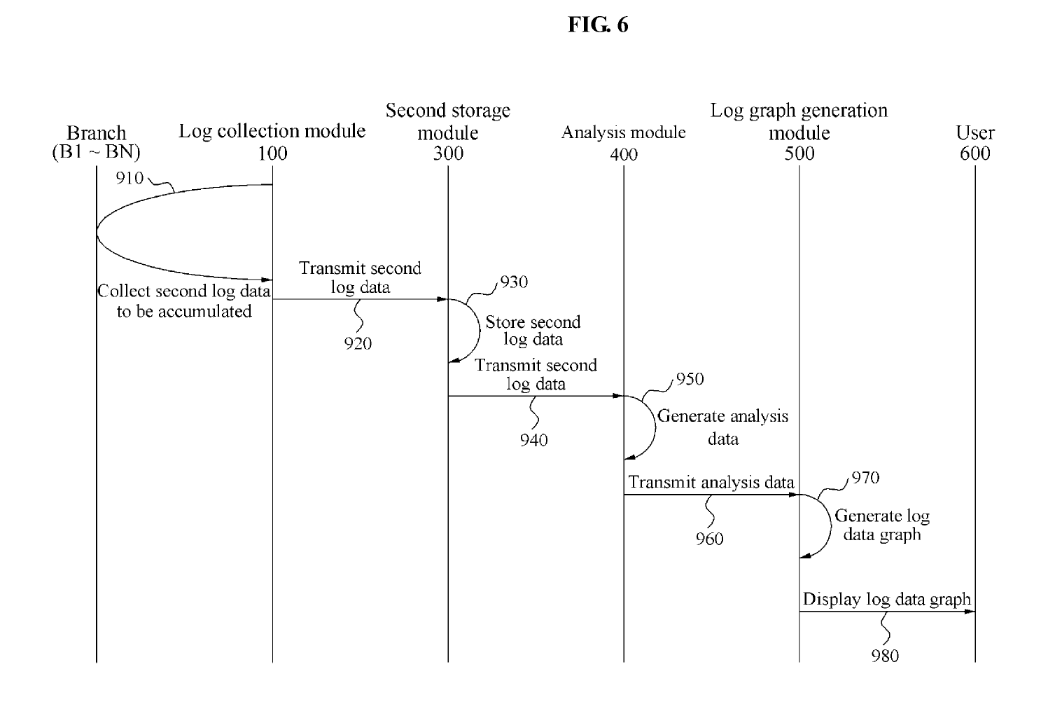

FIG. 6 is a data flowchart illustrating still another example of an operating method of the log data processing system 10 illustrated in FIG. 1.

Referring to FIG. 6, in operation 910, the log collection module 100 collects second log data to be accumulated by a task process associated with a customer at each of branches B1 through BN. In operation 920, the log collection module 100 transmits the second log data to the second storage module 300.

In operation 930, the second storage module 300 stores the second log data transmitted from the log collection module 100. In operation 940, when the second log data is a large amount of data, the second storage module 300 transmits the second log data to the analysis module 400.

In operation 950, the analysis module 400 analyzes the second log data transmitted from the second storage module 300 using a distributed and parallel processing method, and generates analysis data obtained as a result of the analyzing. In operation 960, the analysis module 400 transmits the analysis data to the log graph generation module 500.

In operation 970, the log graph generation module 500 generates a log data graph of the analysis data transmitted from the analysis module 400. In operation 980, the log graph generation module 500 displays the log data graph in a form of a web interface to allow the user 600 to view the log data graph.

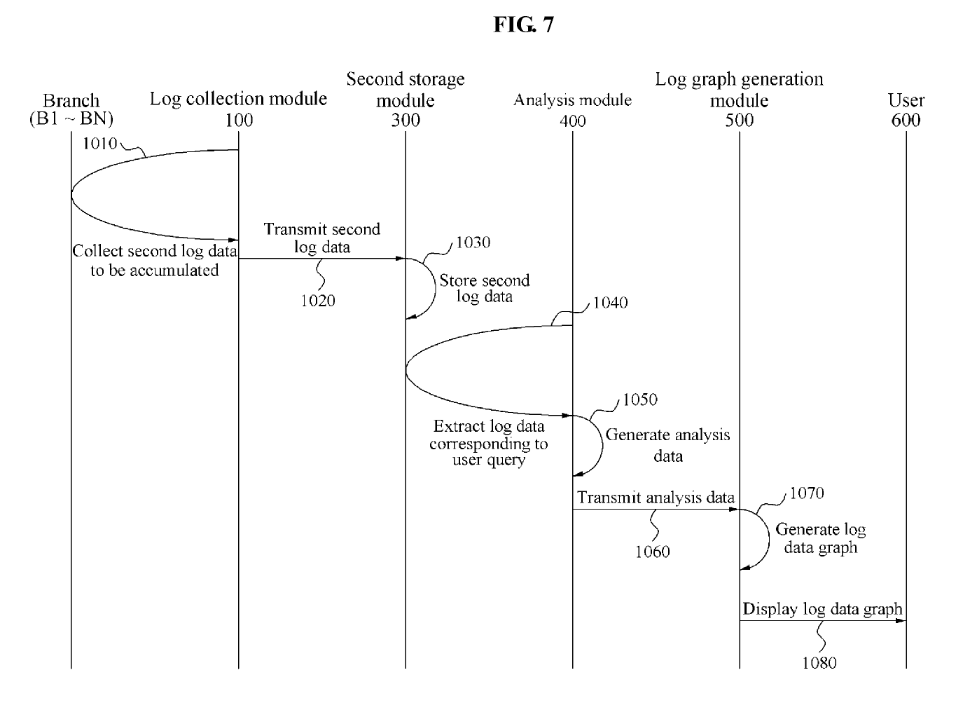

FIG. 7 is a data flowchart illustrating yet another example of an operating method of the log data processing system 10 illustrated in FIG. 1.

Referring to FIG. 7, in operation 1010, the log collection module 100 collects second log data to be accumulated by a task process associated with a customer at each of branches B1 through BN. In operation 1020, the log collection module 100 transmits the second log data to the second storage module 300.

In operation 1030, the second storage module 300 stores the second log data transmitted from the log collection module 100.

In operation 1040, the analysis module 400 extracts log data corresponding to a user query from the second log data stored in the second storage module 300 in response to the user query. In operation 1050, the analysis module 400 analyzes the extracted log data using a distributed and parallel processing method, and generates analysis data obtained as a result of the analyzing. In operation 1060, the analysis module 400 transmits the analysis data to the log graph generation module 500.

In operation 1070, the log graph generation module 500 generates a log data graph of the analysis data transmitted from the analysis module 400. In operation 1080, the log graph generation module 500 displays the log data graph in a form of a web interface to allow the user 600 to view the log data graph.

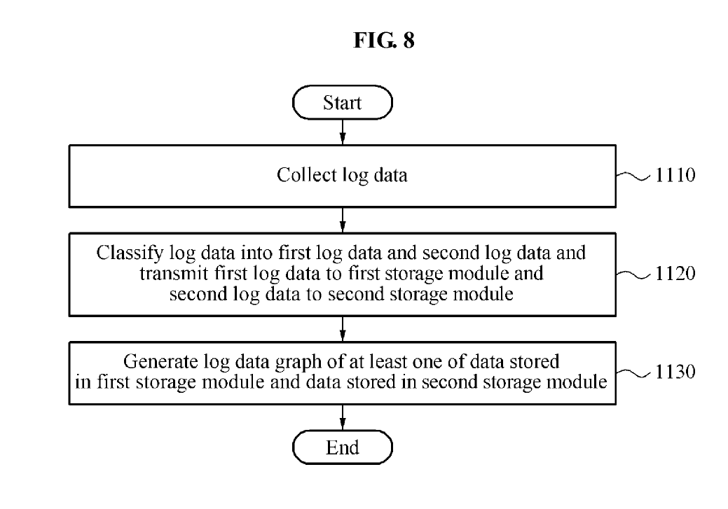

FIG. 8 is a flowchart illustrating an example of an operating method of the log data processing system 10 illustrated in FIG. 1.

Referring to FIG. 8, in operation 1110, the log collection module 100 collects log data generated by a task process associated with a customer at each branch.

In operation 1120, the log collection module 100 classifies the log data into first log data and second log data based on a type of the log data, and transmits the first log data to the first storage module 200 and second log data to the second storage module 300. The first storage module 200 stores the first log data, and the second storage module 300 stores the second log data.

In operation 1130, the log graph generation module 500 generates a log data graph of at least one of data stored in the first storage module 200, for example, the first log data, and data stored in the second storage module 300, for example, the second log data.

The modules or units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The above-described example embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A log data processing system, comprising:
a first storage module;
a second storage module;
a log collection module configured to collect log data generated by a task associated with a customer, classify the log data into first log data and second log data based on a type of the log data, and transmit the first log data to the first storage module and the second log data to the second storage module; and
a log graph generation module configured to generate a log data graph of at least one of data stored in the first storage module and data stored in the second storage module.

2. The system of claim 1, further comprising:
an analysis module configured to extract log data corresponding to a user query from the second log data transmitted to the second storage module in response to the user query, and analyze the extracted log data using a distributed and parallel processing method, and
wherein the log graph generation module is configured to generate a log data graph of analysis data obtained by the analysis module.

3. The system of claim 2, wherein, when the second log data is a large amount of data, the second storage module is configured to transmit the second log data to the analysis module, and
the analysis module is configured to analyze the second log data using the distributed and parallel processing method.

4. The system of claim 2, wherein the user query comprises at least one of a time based condition, a date based condition, a month based condition, a year based condition, and a branch based condition.

5. The system of claim 1, wherein the log collection module is configured to collect the log data during a period of time spanning from a start point of the task to an end point of the task.

6. The system of claim 1, wherein the first log data is data requiring a real time analysis, and the second log data is data requiring a unit time analysis.

7. The system of claim 1, wherein the log graph generation module is configured to display the log data graph in a form of a web interface.

8. The system of claim 1, wherein the second storage module is configured to perform an autoshading operation on the second log data.

9. The system of claim 1, wherein the log collection module is configured to determine the type of the log data based on a parameter comprised in the log data.

10. The system of claim 1, wherein the second storage module is configured to combine the first log information transmitted to the first storage module and information associated with the first log data through a Sqoop, and store the combined first log data and the information subsequent to an end point of the task.

11. The system of claim 10, wherein the information associated with the first log data comprises at least one of a wait time for the task, a processing time for the task, and information on a worker handling the task.

12. A log data processing method of a log data processing system comprising a first storage module and a second storage module, the method comprising:
collecting log data generated by a task associated with a customer;
classifying the log data into first log data and second log data based on a type of the log data, and transmitting the first log data to the first storage module and the second log data to the second storage module; and
generating a log data graph of at least one of data stored in the first storage module and data stored in the second storage module.

13. The method of claim 12, further comprising:
extracting log data corresponding to a user query from the second log data stored in the second storage module in response to the user query;
analyzing the extracted log data using a distributed and parallel processing method; and
generating a log data graph of analysis data obtained as a result of the analyzing.

14. The method of claim 12, wherein the collecting comprises collecting the log data during a period of time spanning from a start point of the task to an end point of the task.

15. The method of claim 12, wherein the transmitting comprises determining the type of the log data using a parameter comprised in the log data.

16. The method of claim 12, further comprising:
displaying the log data graph in a form of a web interface.

17. The method of claim 12, further comprising:
combining the first log data and information associated with the first log data and transmitting the combined first log data and the information to the second storage module subsequent to an end point of the task.

18. The method of claim 12, further comprising:
performing an autoshading operation on the second log data.

19. The method of claim 12, wherein the first log data is data requiring a real time analysis, and the second log data is data requiring a unit time analysis.

20. A non-transitory computer-readable recording medium comprising a program for instructing a computer to perform the method of claim 12.
